(19) United States
(12) Patent Application Publication
(10) Pub. No.: US 2018/0323445 A1
(43) Pub. Date: Nov. 8, 2018

(54) ELECTRODE FOR REDOX FLOW BATTERY

(71) Applicant: Avalon Battery (Canada) Corporation, Vancouver (CA)

(72) Inventors: Che-Nan Sun, Williamsville, NY (US); David Genders, Elma, NY (US); Peter Symons, Williamsville, NY (US)

(21) Appl. No.: 15/775,676

(22) PCT Filed: Nov. 9, 2016
(86) PCT No.: PCT/US16/61204

§ 371 Date: May 11, 2018

Related U.S. Application Data
(60) Provisional application No. 62/254,711, filed on Nov. 13, 2015.

(51) Int. Cl. H01M 4/96; H01M 4/04; H01M 4/88; H01M 8/18

(52) U.S. Cl. CPC H01M 4/96; H01M 4/0419; H01M 4/0471; H01M 8/188; H01M 4/8846

(57) ABSTRACT

Porous carbon felt electrodes for a redox flow battery can be improved by suitably oxidizing the porous carbon felt or by oxidizing carbon particles impregnated into the porous carbon felt. The electrode resistance and voltage efficiency of cells comprising such electrodes can be substantially improved. The invention is particularly suitable for use in vanadium redox flow batteries.

### TECHNICAL FIELD

The present invention pertains to electrodes for redox flow batteries, and particularly to electrodes based on porous carbon felts for vanadium redox flow batteries.

### BACKGROUND

Redox flow batteries, such as vanadium redox flow batteries, continue to show promise for storing large amounts of electrical energy, such as for load levelling applications. A redox flow battery with a low internal resistance is desirable for attaining high efficiency operation, high power density and for driving reductions in cost. In a redox flow battery, there are three major processes that contribute to the internal cell resistance, namely electrode reaction kinetics, ohmic losses and diffusion processes. The kinetic overpotential is associated with the processes taking place at the electrode surface during battery operation. Factors that can affect the kinetic overpotential include electrode surface area (which impacts the real current density), operating temperature, reaction constant of the redox chemistry, and concentration of the active material. For instance, high surface area porous electrodes are commonly used in such batteries in order to reduce the kinetic overpotential. The ohmic overpotential reflects the electronic resistance, ionic resistance, and contact resistance in the battery. High component conductivities along with a short conduction path are desirable to reduce the electronic and the ionic resistances. In a typical redox flow battery, the electronic resistance is largely determined by the electronic conductivity and the thickness of both the bipolar plates and the electrodes therein. The ionic resistance is associated with the characteristics (thickness, ionic conductivity) of the membrane/separator and the electrolyte therein. In addition, a typical redox battery comprises a stack of multiple layers of components. Between each interface, a contact resistance exists which further contributes to the ohmic overpotential during operation. The diffusion overpotential represents the voltage loss that is required to bring the active species to the electrode surface. Generally, the diffusion overpotential is sensitive to the concentration of the active species, diffusion coefficient, porous structure, and flow characteristics. In order to realize a high performance redox flow battery, it will be important to optimize these factors via advanced cell design, and preferably with inexpensive materials.

To enhance performance, porous electrodes are typically employed in redox flow batteries to increase the available surface area for better efficiency. The most commonly used porous materials are carbonaceous felts and papers due to their good electronic conductivity, high stability and low cost. However, battery performance can be limited when using pristine commercially available carbon felts and papers due to slow inherent kinetics (particularly on the V2/3 side of a vanadium redox battery). As a result, modifications of carbon electrodes made with these materials are generally needed in order to improve the performance further. At the moment, the modification methods being considered include heat treatment, electrochemical plating of the catalyst materials, and impregnation of various suitable additives including carbon and hydrophilic modifiers.

Heat treatment is probably the most commonly used method to modify such carbon electrodes. In this method, the porous carbon material in the electrode is treated at elevated temperature (i.e. over 400° C.) in an oxygen containing atmosphere (e.g. air) for a sufficient time (e.g. minutes to several hours) in order to achieve oxidation of the porous carbon material to varying degrees. Thus, advantages of this treatment approach include simplicity and low cost. Oxidized felts or papers show enhanced performance presumably due to increased surface area and/or the incorporation of functional groups on the carbon surfaces which promote the desired electrochemical processes. Heat-treated carbonaceous papers, cloths, and felts have been adopted as redox flow battery electrodes and show significant performance improvements. However, carbon paper is characterized by relatively high costs and thin dimensions (e.g. 200-400 μm) and thus a serpentine flow field on the bipolar plates, or other electrolyte distribution means, are usually required in a flow battery in order to operate at reasonable hydraulic pressure. The performance improvement is significant but these requirements raise the system capital cost. Carbon felts on the other hand, while less expensive, have a greater thickness and pore size and therefore do not require the flow field and mechanical support provided by an adjacent bipolar plate. As a result, a low cost and thin bipolar plate can be used in such a system. Nevertheless, the relatively low surface area and larger thickness of such felts introduce a higher kinetic overpotential and longer ionic conduction pathway, and therefore the cell resistance is higher. Further improvement is thus desirable.

An alternative way to facilitate the reaction kinetics of a porous electrode is to incorporate catalyst material into the carbon felt or paper. The successful catalyst should be stable, low cost, and highly electrically conductive. Moreover, the incorporated catalyst should have a high hydrogen evolution overpotential, and should not negatively impact the other cell components (e.g. membrane and electrolyte) if dissolved. Moreover, the presence of any metal containing catalyst or hydrophilic modifier should not promote side reactions such as (but not limited to) hydrogen, oxygen or chlorine evolution. It appears challenging to identify a catalyst that fulfills all the criteria according to the available literature.

Recently, as disclosed in the Journal of The Electrochemical Society, 161 (6) A1132-A1138 (2014), carbon electrodes were decorated with carbonaceous particles to enhance the active area and these electrodes were demonstrated to have improved cell performance. In this case, the hydrophilicity of the additive was important in order to access the useful surface area as well as develop a network for ionic conduction. In some cases, TiO₂ particles had been impregnated with carbon particles serving as a wetting agent (to improve the electrode wettability) and a polymeric material was employed as a binder to anchor the carbon particles to the carbon fiber matrix. However, the TiO₂ and the polymer binder do not participate in the electrochemical reactions and may block some of the active sites. In addition, the through-plane distribution of the carbon particles is expected to be crucial to control the reaction zone and therefore minimize the voltage loss due to ionic and electronic conduction in the electrode. This point had not been extensively addressed.

While there have been many advances towards improving electrodes for redox flow batteries, there is still a need for lower resistance, higher efficiency designs. The present invention addresses this need and provides other benefits as disclosed below.

### SUMMARY

The present invention provides improved porous carbon felt electrodes for redox flow batteries by suitably oxidizing carbon particles impregnated into the porous carbon felt. The carbon particles are suitably oxidized when the oxidation is sufficient to make the particles wettable by water. The electrode resistance and voltage efficiency of cells comprising such electrodes can be substantially improved due to enhanced surface area and hydrophilicity.

The invention comprises a sheet of porous carbon felt in which both carbon particles and ionomer have been impregnated into the porous carbon felt, and in which the impregnated carbon particles have been oxidized. In a preferred embodiment, the electrode may comprise both a sheet of porous carbon felt which has been oxidized at a temperature above 500° C., and impregnated carbon particles which have been oxidized.

In yet another potential embodiment of the invention, oxidized carbon particles may be deposited directly (e.g. in combination with ionomer) onto the membrane electrolyte, thereby forming the improved electrode directly on the membrane. Such an embodiment would thus be an electrolyte/electrode assembly and could be considered as a carbon catalyst coated membrane. A porous carbon felt or other porous, conducting material may optionally be located adjacent the carbon catalyst coated membrane.

A suitably oxidized porous carbon felt may have been oxidized in air at 600° C. for about 20 minutes. The improved carbon felts may typically be less than or about 5 mm thick, and particularly less than or about 3 mm thick. Suitable carbon felts for use in the invention include pyrolyzed polyacrylonitrile felts.

Suitable carbon particles for use in the invention include carbon black or activated carbon. The carbon particles can be suitably oxidized in a variety of ways, including chemical treatment, thermal treatment, and electrochemical treatment. For instance, the carbon particles can be oxidized by a chemical treatment method comprising exposing the carbon particles to an appropriate strength persulfate (e.g. 1M ammonium persulfate) for a sufficient time at a suitable temperature (e.g. 70° C.). Alternatively, the carbon particles can be oxidized by a thermal treatment method comprising exposing the carbon particles to air (e.g. in a fluidized bed arrangement) in a range between about 350 and 750° C. In yet another alternative, the carbon particles in the carbon-particle-decorated carbon felt may be oxidized electrochemically, for instance by operating as a positive electrode for a suitable period. Cell polarity can then be reversed to allow the oxidized felt to serve as the negative electrode in the subsequent operation or to perform the electrochemical oxidation on the opposite electrode. The carbon particles have been suitably oxidized when the oxidation is sufficient to render the particles wettable by water.

In relevant embodiments, the specific loading of the impregnated carbon particles to the sheet of carbon felt can desirably be in the range from about 0.5 to 2.3 mg/cm². Further, the ionomer employed can be a perfluorosulfonic acid polymer and the weight ratio of the ionomer to the carbon particles can desirably be less than or about 0.05.

The present invention includes improved electrodes for redox flow batteries and redox flow batteries comprising such electrodes. The invention is particularly suitable for use in vanadium redox flow batteries. The invention further includes methods for making such electrodes. In one embodiment, the method comprises obtaining a suitable sheet of porous carbon felt, carbon particles and ionomer, preparing a mixture of the oxidized carbon particles, the ionomer, and a solvent, impregnating the mixture into the porous carbon felt, and finally removing (e.g. via drying) the solvent from the impregnated porous carbon felt. The impregnating step may be accomplished in various ways known to those skilled in the art. For instance, the impregnating step can comprise spraying or soaking the porous carbon felt with the solution mixture. Alternatively, the impregnating step can comprise painting or mechanically coating the porous carbon felt with a suitably prepared mixture.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and not limited to just one.

In addition, the following definitions are intended. In a numerical context, the word “about” is to be construed as meaning plus or minus 10%.

Carbon felt, as defined herein, is comprised of carbon fibers which have been formed into a mat substantially thicker than a single fiber with a high porosity (i.e. % void volume>70%) via a mechanical needle punch process. The formed or “felted” mat can be created from non-pyrolyzed fibers such as rayon or polyacrylonitrile (PAN). Alternatively, the felt mat may be created from partially or fully oxidized carbon fibers. Pyrolyzing conditions vary greatly but are typically between 700-2300° C. in an inert atmosphere. Carbon felt is distinct and different from other forms of carbon sheet such as woven and non-woven papers which are not formed using a needle punch step and are characteristically much thinner than carbon felt.

Further, carbon particles are considered to be “wettable by water” herein when most of the mass of the sample particles is found either to sink or to form a suspension after initially mixing a small representative sample of the particles in de-ionized water. In contrast, non oxidized particles which are not “wettable by water” float on the surface of the de-ionized water.

The present invention relates to electrodes and methods for making electrodes in order to improve the performance of redox flow batteries. Obtaining the greatest performance out of a redox battery requires minimizing both the kinetic and ohmic losses. As is often the case, a compromise may need to be made since a higher surface area electrode (which might be achieved for instance by using a thicker material such as a thicker carbon felt) would improve the apparent kinetics (at a given geometric current density) but may lead to higher ohmic resistance of the electrode. However, by incorporating high surface area particles at a suitable location, it may be possible to shift the reaction zone towards the membrane electrolyte and reduce the distance of ionic conduction. This would then allow the use of a felt electrode structure at low ohmic loss and cost. In one aspect of the present invention, oxidized carbon particles serve as such a high surface area catalyst with active sites. The carbon particles are incorporated or impregnated into a porous carbon matrix (e.g. carbon felt). The presence of these oxidized carbon particles can result in improvements in electrode resistance and efficiency when employed in a redox battery.

Suitable carbon particles to be oxidized and incorporated in accordance with the invention include carbon black, activated carbon, and other high surface area forms of carbon. Suitable methods for oxidizing the carbon particles before incorporation into a porous carbon felt include chemical, heat, and/or electrochemical treatments. A suitable chemical treatment can involve contacting the carbon particles with oxidizing agents other than air and/or oxygen to cause a carbon oxidation reaction on the particles. A suitable thermal treatment can involve contacting the carbon particles with air and/or oxygen containing gases while thermally heating to cause a carbon oxidation reaction on the particles. A suitable electrochemical treatment can involve using electrochemical treatment to cause a carbon oxidation reaction on the particles. As demonstrated in the Examples below, an effective chemical treatment comprises exposing the carbon particles to a concentrated persulfate solution for an appropriate time at an appropriate temperature. It is also expected that heating in air in a range between about 350 and 750° C. would also be effective. Further, it should also be possible to effect oxidation using an appropriate electrochemical treatment. Such oxidation treatments introduce oxygen functionality onto the carbon surface and improve hydrophilicity, and can result in increased useful electrode surface area.

After oxidation, the carbon particles can then be impregnated into a suitable porous carbon felt via an ink type application method. (Alternatively, other application methods may be employed instead. For instance, the carbon particles may be impregnated using an appropriate mechanical coating method.) When using an ink type application method, initially an ink is prepared by mixing the oxidized, high surface area carbon particles with a binder (e.g. Nafion®, PVDF, Teflon, or other polymers) in one or more solvents (e.g. aqueous, non-aqueous, or mixtures thereof). Preferably the binder is an ionomer such as perfluorosulfonic acid polymer to avoid blocking access of the electrolyte to the particle surfaces. Further, the amount of binder is preferably kept low (e.g. ionomer/carbon weight ratio of about less than 0.05) to enhance the accessibility of the active sites. The ink may be sonicated and/or stirred to achieve a homogeneous distribution.

The prepared ink is subsequently applied to the porous carbon felt via application techniques such as airbrushing, spraying, painting, or soaking. As shown in Examples below, a soaking technique may be preferred in order to increase the weight of carbon impregnated and improve results. The impregnated carbon electrode is then dried in order to remover the carrier solvent, for instance in an oven, at temperatures ranging from room temperature up to 200° C., in air or under vacuum.

With regards to oxidizing the porous carbon felt in accordance with the invention, a suitable method can simply involve heating a selected felt to a temperature exceeding 500° C. in air for a given time. As with the carbon particles, oxidizing the felt in this way should further increase the oxygen functionality and enhance wettability of the carbon felt in the electrode.

Advantages of impregnating oxidized carbon particles into the carbon felts of such electrodes include increasing the electrode surface area and allowing the use of thinner felts without the penalty of a kinetic overpotential increase. In turn, a thinner carbon felt should offer lower electronic resistance due to shorter electronic conduction path. Moreover, focusing the carbon impregnation on the side of the electrode which contacts the membrane/separator should assure that the high surface area is provided closer to the electrode/membrane interface. Utilizing the hydrophilic nature of the carbon particles, the reaction zone should be directed toward the electrode/membrane interface and thus reduce the ion conduction path. This is particularly helpful in the case where the ionic conductivity is lower than the electronic conductivity, which is more likely in electrochemical systems. The resulting electrode would have high surface area and a structure with large open pores (being a property of the porous carbon felt) thereby facilitating electrochemical processes (kinetics and mass transport) without the assistance of an external flow field. Further, the use of carbon particles provides the potential for tailoring properties of the product electrode. The geometry, functional groups, and properties of the carbon particles can themselves be tailored before impregnating into a felt in order to optimize performance. Functional groups on the carbon surface can be further modified to facilitate electron transfer kinetics, electrolyte access (wettability), and mass transfer limitations.

General advantages of the invention, whether oxidizing carbon particles to be impregnated or oxidizing the host carbon felt or both, include simplicity and cost. For instance, no electrochemical process need be involved and the majority of the materials required are solvents and carbons which can both be relatively inexpensive. Either process of course results in a higher performance electrode material with potentially high durability. Further, the methods offer flexibility in that a distributed electrochemical surface area can be realized throughout the electrode thickness and thus further control the reaction zone. A yet further potential advantage of a high surface area electrode with improved electrode kinetics is that by operating at lower overpotentials, it may be possible to relax the metallic contaminant specifications required of the electrolytes used.

Without being bound by theory, it is believed that the oxidation steps involved in the present invention generally increase activity for desirable electrochemical reactions by adding surface area and functional oxygen groups on the carbon surface. Further, the presence of these groups increase hydrophilicity and hence access of electrolyte to the various carbon surfaces. The effect on electrode performance is surprisingly substantial.

The following Examples have been included to illustrate certain aspects of the invention but should not be construed as limiting in any way.

### EXAMPLES

A series of electrodes and both laboratory type and commercial size vanadium redox flow batteries were made and tested in order to compare the characteristics of electrodes and cells of the invention to those of a conventional electrodes and cells.

Sample electrodes were prepared using commercially available porous carbon felts in selected thicknesses. The carbon felts were all prepared by pyrolyzing precursor polyacrylonitrile felts. As summarized in Table 1 below, certain sample felts were initially oxidized by heating in air at the indicated temperature for the indicated amount of time.

For some samples, carbon particles were impregnated into the carbon felt using an ink type application method. The carbon particles were a commercially available carbon black (Vulcan XC-72). The wettability of the carbon black was determined by taking a 50 mg sample and mixing into a test tube of 5 ml of de-ionized water. Virtually all the mass of the particles floated indicating that the commercially obtained carbon particles were not wettable by water as defined herein.

Where indicated, the carbon particles were first oxidized using a chemical treatment method comprising soaking the particles in 1M ammonium persulfate solution at 70° C. for about 2 hours. After soaking, the solution was cooled and filtered off using 0.02 μm filter paper. The carbon particles were then rinsed with distilled water and dried overnight under vacuum at 100° C. The wettability of the oxidized carbon black particles was then determined in a similar manner. Here, virtually all the mass of the particles formed a homogeneous suspension in the test tube indicating that the oxidized carbon particles were wettable by water.

The impregnating inks were prepared by mixing together the appropriate carbon black and isopropanol and then sonicating. Nafion® ionomer dispersion was then added and stirred and finally additional isopropanol solvent was added. The ionomer to carbon particle weight ratio in these mixtures, and hence in the sample electrodes produced, are indicated in Table 1 below. In these Examples, the inks were either applied by an airbrush spraying method or by a soaking method. The impregnated sample felts were then dried at ambient temperature for about 1 hour and then in air at 90° C. for several more hours. The spraying application method applies the ink solids preferentially one side of the felt. The soaking method applies the ink solids more uniformly throughout the felt. Consequently the weight of solids applied using the spraying method was significantly less than that applied by soaking. The weight of solids applied also is indicated in Table 1 below.

Laboratory type single cell vanadium redox batteries were then prepared using the prepared electrode samples in cells comprising a separating ionomer membrane electrolyte. In all cases where airbrush spraying had been used, the felt electrodes were oriented in such a way that the airbrushed side was located against the ionomer membrane. In initial testing, microcells (about 10 cm² in area) were made with perfluorosulfonic acid ionomer membranes or anion membranes sandwiched by two similarly prepared electrode samples. The assemblies were compressed between bipolar plates allowing the electrolyte (approximately 1.8M vanadium/4.2 M sulfate) access to the electrodes. Preliminary values of the kinetic and ohmic resistances were measured and, in all but one instance, the values were evaluated to warrant further, more thorough testing. This was accomplished by testing a larger electrode area in larger redox cells. (The resistance of comparative sample 3 was so high in microcell testing that a larger redox cell was not made therewith. Instead, an estimate of the electrode characteristics based on the microcell results was provided in Table 1 below.) These larger redox cells were about 170 cm² in area. Here, identical felt samples were applied to both sides of the membrane. Again, bipolar plates were used to compress the assemblies together and again a liquid electrolyte of approximately 1.8M vanadium/4.2 M sulfate was supplied to the cell.

The larger, single cell, redox cells were operated and performance characteristics were determined. In summary Table 1 below, the cell temperature and current density used in the testing are indicated. Where determined, the resistance of the electrode, the voltage efficiency (VE), the energy efficiency (EE) and the estimated peak power density expected from a cell comprising such electrodes are provided. In particular, the peak power density is estimated through equation P=E²/4R, where P is the peak power density, E is the cell open circuit voltage (OCV) and R is the total equivalent area specific resistance, including over-potential, diffusion and mass transport.

Herein, columbic Efficiency (CE) is the ratio of measured amps-hrs (Ah) input to the system under test divided by the measured amp-hrs (Ah) discharged from the test system at the stated constant current charge/discharge conditions while operating the cell over the full operating state of charge (SOC) range, typically between 15 and 85% SOC. Energy Efficiency (EE) is the ratio of measured kWh input to the system under test divided by measured kWh discharged from the test cell at the stated constant current charge/discharge conditions while operating the cell over the full operating SOC range, typically between 15 and 85% SOC. Voltaic Efficiency (VE) is calculated as the ratio of EE/CE.

TABLE 1

| | Carbon felt | Carbon | | | | | | | |
|---|---|---|---|---|---|---|---|---|---|
| | thickness; and | added?; and | Carbon | Ionomer to | | | | | Est. peak |
| | heat treatment | method & | oxidation?; and | carbon weight | Testing temp and | Resistance | | | power |
| Sample | (HT) | amount added | method | ratio | current density | (ohm cm²) | VE | EE | (mW/cm²) |
| 1 | 4 mm; no HT | No | Not applicable | Not applicable | 35° C.; 80 mA/cm² | 2.08 | 79% | | |
| 2 | 4 mm; 650° C. for | No | Not applicable | Not applicable | 35° C.; 80 mA/cm² | 1.17 | 87% | | |
| | 30 min | | | | | | | | |
| 3* | 2.5 mm; no HT | Yes; spray; | Not applicable | 0.1 | 35° C.; 80 mA/cm² | >2 | n/a | | |
| | | ~0.5 mg/cm² | | | | (estimated) | | | |
| 4 | 3 mm; 600° C. for | Yes; spray; | Treated with | 0.05 | 35° C.; 80 mA/cm² | 0.93 | 89% | 82% | 605 |
| | 20 min | ~0.5 mg/cm² | 1M persulfate at | | 45° C.; 80 mA/cm² | 0.78 | 90% | 84% | 721 |
| | | | 70° C. for ~2 | | | | | | |
| | | | hours | | | | | | |
| 5 | 3 mm; 600° C. for | No | Not applicable | Not applicable | 35° C.; 80 mA/cm² | 1.09 | 88% | | |
| | 20 min | | | | | | | | |
| 6 | 3 mm; 600° C. for | Yes; soak; | Not applicable | 0.01 | 35° C.; 80 mA/cm² | 0.95 | 89% | 85% | 592 |
| | 20 min | ~2.3 mg/cm² | | | 35° C.; 160 mA/cm² | 0.95 | 81% | 78% | |
| 7 | 4 mm; 650° C. for | No | Not applicable | Not applicable | 35° C.; 160 mA/cm² | 1.20 | 77% | | |
| | 30 min | | | | | | | | |
| 8 | 3 mm; 600° C. for | No | Not applicable | Not applicable | 35° C.; 160 mA/cm² | 1.14 | 78% | | |
| | 20 min | | | | | | | | |
| 9 | 3 mm; 600° C. for | Yes; spray; | Treated with | 0.05 | 35° C.; 160 mA/cm² | 0.99 | 81% | 78% | 568 |
| | 20 min | ~0.5 mg/cm² | 1M persulfate at | | | | | | |
| | | | 70° C. for ~2 | | | | | | |
| | | | hours | | | | | | |
| 10 | 4 mm; 650° C. for | No | Not applicable | Not applicable | 35° C.; 139 mA/cm² | 1.43 | 79% | | |
| | 30 min | | | | | | | | |
| 11 | 4 mm; 650° C. for | Yes; spray; | Treated with | 0.05 | 35° C.; 139 mA/cm² | 1.26 | 78% | | |
| | 30 min | ~0.5 mg/cm² | 1M persulfate at | | | | | | |
| | | | 70° C. for ~2 | | | | | | |
| | | | hours | | | | | | |

*This sample was only evaluated in the 10 cm² laboratory cell due to the very high initial resistance observed.

In the above results, note that resistance values are generally lower and voltage efficiencies are generally higher at higher testing temperatures. However, voltage efficiencies are generally lower at higher testing current densities.

The comparative sample 1 represents a typical conventional vanadium redox battery embodiment. A relatively thick (4 mm) carbon felt was used here with no additional oxidation performed on the felt and no carbon particles were added.

The comparative sample 3 used a substantially thinner carbon felt (2.5 mm) but incorporated carbon particles therein for potential improvement. No additional oxidation was performed on the felt and the impregnated carbon particles were not oxidized in this example. The resistance results here were unacceptably poor. The electrode was found to be highly hydrophobic with a kinetic resistance about 5 times higher and an ohmic resistance about 15 times higher than subsequently prepared oxidized (hydrophilic) electrodes.

At any given set of testing conditions, in all cases where the carbon felt was oxidized at 600° C. or above, there was a significant improvement in electrode resistance and in voltage efficiency for the redox battery. Further, in all cases where oxidized carbon particles were impregnated into the carbon felt, there was a significant improvement in electrode resistance and in voltage efficiency. The best performance however was obtained in sample 4 where both the carbon felt was oxidized at higher than conventional temperatures and oxidized carbon particles were additionally impregnated into the felt.

It further appears from the results obtained with sample 6 that the soaking method of applying the ink not only leads to a greater weight of impregnated carbon particles, but also to a substantial improvement in resistance and voltage efficiency as well, when compared to the spray method of application.

Two additional vanadium redox batteries were then prepared using even larger (4.5 times or about 750 cm²) electrodes in multi-cell stacks in a format similar to commercial embodiments. A comparative stack (sample 10) comprising 8 cells electrically in series was made using oxidized carbon felt electrodes but without any incorporated carbon particles. A stack of the invention (sample 11) comprising 2 cells in series was also made using similar oxidized carbon felt electrodes in which oxidized carbon particles had been incorporated as described above. The results obtained with these two stacks are also summarized in Table 1. These results show that the carbon particle incorporation provides a further 12% reduction in resistance and improved VE during operation of the stack. The inventive stack employed identical membrane and current collector/bipolar plate material as was employed in the laboratory type cells. However, the geometric area of the stack was 4.5 times larger than that of the laboratory cell. These example results demonstrate that the method of application of the oxidized particles can be successfully scaled up to a commercial stack cell area and shows comparable performance improvements.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. An electrode for a redox flow battery comprising:
a sheet of porous carbon felt;
carbon particles impregnated into the porous carbon felt; and
ionomer impregnated into the porous carbon felt;
characterized in that the carbon particles are oxidized such that they are wettable by water.

2. The electrode of claim 1 wherein the porous carbon felt is oxidized at a temperature above 500° C.

3. The electrode of claim 2 wherein the carbon felt is oxidized in air at 600° C. for about 20 minutes.

4. The electrode of claim 1 wherein the carbon felt is less than or about 3 mm thick.

5. The electrode of claim 1 wherein the carbon felt is a pyrolyzed polyacrylonitrile felt.

6. The electrode of claim 1 wherein the carbon particles are carbon black or activated carbon.

7. The electrode of claim 1 wherein the carbon particles are oxidized by a method selected from chemical treatment, thermal treatment, and electrochemical treatment.

8. The electrode of claim 7 wherein the carbon particles are oxidized by a chemical treatment method comprising exposing the carbon particles to 1M ammonium persulfate at 70° C.

9. The electrode of claim 7 wherein the carbon particles are oxidized by a thermal treatment method comprising exposing the carbon particles to air in a range between about 350 and 750° C.

10. The electrode of claim 7 wherein the specific loading of the impregnated carbon particles to the sheet of carbon felt is in the range from about 0.5 to 2.3 mg/cm².

11. The electrode of claim 1 wherein the ionomer is a perfluorosulfonic acid polymer.

12. The electrode of claim 1 wherein the weight ratio of the ionomer to the carbon particles is less than or about 0.05.

13. A redox flow battery comprising the electrode of claim 1.

14. The redox flow battery of claim 13 wherein the battery is a vanadium redox flow battery.

15. A method for making the electrode of claim 1 comprising:
obtaining the sheet of porous carbon felt, the oxidized carbon particles and the ionomer;
preparing a mixture of the oxidized carbon particles, the ionomer, and a solvent;
impregnating the mixture into the porous carbon felt; and
removing the solvent from the impregnated porous carbon felt.

16. The method of claim 15 wherein the impregnating step comprises soaking the porous carbon felt in the mixture.

17. The method of claim 15 wherein the impregnating step comprises spraying the porous carbon felt with the mixture.

18. The method of claim 15 wherein the impregnating step comprises painting or mechanically coating the porous carbon felt with the mixture.
